(19) United States
(12) Patent Application Publication
(10) Pub. No.: US 2010/0253466 A1
(43) Pub. Date: Oct. 7, 2010

(54) Method of Electromagnetic Induction

(76) Inventor: Lawrence Wright, (US)

Correspondence Address: Lawrence Wright, 5820 W Sample Rd, 201, Coral Springs, FL, 33067, US

(21) Appl. No.: 12/416,885

(22) Filed: Apr. 1, 2009

(51) Int. Cl. H01F 27/28

(52) U.S. Cl. 336/225

(57) ABSTRACT

This invention discloses the method of producing electromagnetic induction suitable for transformers and electromagnets. This invention provides significant improvements over existing technology. The system consists of primary and secondary conductors wound in a layered geometric configuration using conductors with specific wire diameter or atomic structure ratios. The coil operates through resonance on an AC or oscillating DC power source. This method of electromagnetic induction is capable of or creating an electromagnet or generating electricity in the secondary coil, dependant on the geometry of the configuration.

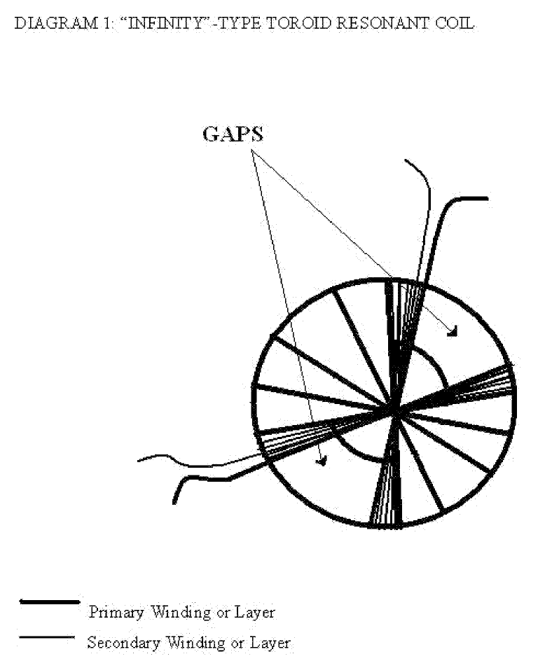

### TECHNICAL FIELD

The invention is a method and apparatus for electromagnetic induction, converting electricity into electromagnetism or vice versa.

### BACKGROUND OF THE INVENTION

The device may be used to construct electromagnetic motors or in the production of electricity for portable devices, circuits, automobile, households, power grids, and more. It may be used in place of ferrous transformers, which diminish amperage during operation. The present invention is ubiquitous, and may be modified to suit any range of applications; not limited to wind generators and solar panels, gas and hydraulic turbines, nuclear energy. The equipment may be classified with portable generators and turbines manufactured by North America Industrial Classification System (NAICS) 335312 and the Standard Industry Classification Codes (SIC) 3621, comprising the electrical power equipment industry and referring to motor and generator manufacturing.

### BRIEF SUMMARY OF THE INVENTION

The present invention operates as an electromagnet or transformer, depending on the geometry, with or without a ferrous core. This creates the opportunity for lighter weight electromagnetic motors, and transformers with increased amperage output. The device operates in a wide range of voltages, from kilovolt to millivolts, by eliminating, the need for a spark gap and other high-power elements used in typical resonant transformers.

### BRIEF DESCRIPTION OF SEVERAL VIEWS OF THE DRAWING

Diagram 1: “Infinity”-wound toroid resonant coil with predetermined layers and multiple gaps where windings cross over and under, or vice versa, at the center. The direction of the windings is inconsequential. This method of winding is used solely for illustration; the device operates effectively with the infinity-winding or any gapped or whole toroid, cylindrical, or geometric shape with diametrically opposed faces.

### DETAILED DESCRIPTION OF THE INVENTION

The device composed of wires or layers of the primary and secondary conductors wound or layered in a geometric configurations using conductive material with specific wire diameter or atomic structure ratios. The coils or layers operate through resonance on an AC or oscillating DC power source. This method of electromagnetic induction is capable of or creating an electromagnet or generating electricity in the secondary coil, dependent on the geometry of the configuration. In the diagram, an electromagnet or transformer is produced using geometric shape with diametrically opposed faces. A gap or gaps may be constructed, of predetermined degree angle, in the geometric shape used to form the device.

The primary wire, or material, is wound or layered to cover the surface area above or below a secondary wire or material, in a geometric form. The secondary wire, or material, is wound or layered to cover the surface area above or below the primary wire or material, in a geometric form. The wire diameter, or atomic structure, of the secondary wire or layer (B) with respect to the primary wire or layer (A), is governed by the equation: B≦2A/(1+√5). The device may have additional windings or layers covering the surface area above or below the primary and or secondary winding or layer; also governed by the above equation with respect to the primary or secondary winding or layer in proximity.

The necessary oscillations to create harmonic resonance may come from an AC source or through an oscillating DC source, such as a resistor-inductor circuit (RL circuit) or other impulse response system. A range of voltages and frequencies may be used in the oscillation in the circuit, though results can be achieved using as low as a 9V, a 1 MHz oscillation circuit, and inducer geometry suited to the purpose of the device. Adjusting the ratio of windings layers or conductive material layers between the primary and secondary layers also changes the device's performance. Both the electromagnet and transformer require the diameter of the material and depths of the layers used in forming the primary and secondary components be in proper proportion.

A cylindrical inducer with a 1-1 ratio between the primary and secondary layers, using a 1 MHz-RL circuit, results in an electromagnet. A 1-1 ratio between the primary and secondary layers in gapped-toroidal geometries creates a transformer capable of inducing approximately one-tenth of the primary layer's voltage in the secondary. Ratios of 1-2, between the primary and secondary layers respectively, result in 1/100^{th} of the primary layer's voltage induced in the same transformer geometry's secondary. Increasing the primary layers in relation to the secondary layers converts transformer-type geometries into electromagnets, and increases electromagnetism for both transformer- and electromagnet-type inducers.

1. A primary wire, or material, wound or layered to cover the surface area above or below a secondary wire or material in a geometric form with diametrically opposed faces.

2. A secondary wire, or material, wound or layered to cover the surface area above or below the primary wire or material. The wire diameter, or atomic structure, of the secondary wire or layer (B) with respect to the primary wire or layer (A), is governed by the equation: B≦2A/(1+√5).

3. The device may have additional windings or layers (B) covering the surface area above or below the primary and or secondary winding or layer (A), governed by the equation: B≦2A/(1+√5).
